(19) United States
(12) Patent Application Publication
(10) Pub. No.: US 2015/0178484 A1
(43) Pub. Date: Jun. 25, 2015

(54) Remote Accessory Management in a Programming Environment for a Progammable Metrology System

(71) Applicant: Mitutoyo Corporation, Kawasaki-shi (JP)

(72) Inventors: John W. McNamara, Seattle, WA (US); Casey Edward Emtman, Kirkland, WA (US)

(21) Appl. No.: 14/137,969

(22) Filed: Dec. 20, 2013

(51) Int. Cl. G06F 21/30

(52) U.S. Cl. CPC G06F 21/305

(57) ABSTRACT

A programming environment for a metrology system comprises a remote accessory managing portion that connects to a remote device (e.g., a user's smart phone or tablet) that is not normally associated with the metrology system. The remote accessory managing portion may comprise an accessory communication portion configured to communicate with a remote device, an accessory authorization portion configured to authorize the remote device for connection to the programming environment, and an accessory data management portion configured to receive and store a set of reference information data from the authorized remote device. The remote accessory managing portion is configured such that when an authorized remote device sends the set of reference information data to the accessory data management portion, it is automatically associated with a current part program instruction representation indicated in at least one of the program editing environment and a user interface of the remote device.

### BACKGROUND

Commonly used programmable metrology systems may include a machine vision inspection system (MVIS) and/or a coordinate measuring machine (CMM). One exemplary prior art MVIS, which can be characterized as a general-purpose “off-line” precision vision system, is the commercially available QUICK VISION® series of PC-based vision systems and QVPAK® software available from Mitutoyo America Corporation (MAC), located in Aurora, Ill. The features and operation of the QUICK VISION® series of vision systems and the QVPAK® software are generally described, for example, in the QVPAK 3D CNC Vision Measuring Machine User's Guide, published January 2003, and the QVPAK 3D CNC Vision Measuring Machine Operation Guide, published September 1996, each of which is hereby incorporated by reference in its entirety.

General-purpose precision machine vision inspection systems, such as the QUICK VISION™ system, are generally programmable to provide automated video inspection. Such systems typically include GUI features and predefined image analysis “video tools” such that operation and programming can be performed by “non-expert” operators. For example, U.S. Pat. No. 6,542,180 (hereinafter “the '180 patent”), which is incorporated herein by reference in its entirety, teaches such a vision system that uses automated video inspection. As taught in the '180 patent, automated video inspection metrology instruments generally have a programming capability that allows an automatic inspection event sequence to be defined by the user for each particular workpiece configuration. Such programming can be implemented as text-based programming, or through a recording mode that progressively “learns” the inspection event sequence by storing a sequence of machine control instructions and individual video tool parameters corresponding to a sequence of inspection operations defined and/or performed by a user (e.g., with the aid of various semi-automatic or automatic video tool operations), or through a combination of both methods. Such a recording mode is often referred to as “learn mode” or “training mode.” In either technique, the machine control instructions and individual video tool parameters are generally stored as a part program that is specific to the particular workpiece configuration, and automatically perform a predetermined sequence of inspection operations during a “run mode” of operation. Part programs for CMMs may be programmed in analogous ways. Exemplary CMMs are disclosed, for example, in U.S. Pat. Nos. 7,251,580; 6,044,569; and 8,516,712, each of which is hereby incorporated herein by reference in its entirety.

Many users and programmers of such metrology systems use the recording mode outlined above in order to create and/or edit part programs. The resulting part program operations or instructions may be represented to such users in a simplified graphical representation, or the like. Many metrology systems are designed such that unskilled users need not view or comprehend the underlying part programming language instructions. Some of the commercially available simplified graphical representations of part programs include the ability to add explanatory and or supplementary information to the part program representation by simplified “comment” statements, or the like. However, such capabilities are typically rudimentary. Adding extensive and/or complex supplementary information at a particular location in a part program representation, and such that it is easily accessible or viewable, is presently beyond the capability of most such systems and most users.

Furthermore, metrology system programming environments have conventionally only been linked to dedicated remote devices such as dedicated tablet devices or teaching pendants, or the like, for example, as disclosed in U.S. Pre-Grant Publication No. 2012/0229662 A1, which is hereby incorporated herein by reference in its entirety. The requirement for such remote devices to have dedicated and/or specially programmed interface features constrains both their availability and their operation. Similar to their associated host systems, such remote devices may require their users to have specialized training to operate them in conjunction with their host system. Furthermore, the user interfaces for such remote devices have typically not been directed toward the problem of making it easy for relatively unskilled users to attach extensive and/or complex supplementary information at a particular location in a part program while operating in a programming environment for the host system. It would be desirable for a user to be able to attach extensive and/or complex supplementary information at a particular location in a part program while operating in a programming environment for the host system, without encountering the aforementioned constraints and deficiencies in the available hardware and methods at their disposal.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a diagram showing various typical components of a general purpose precision machine vision inspection system;

FIG. 2 is a block diagram of a control system portion and a vision components portion of a machine vision inspection system similar to that of FIG. 1, and including features described herein;

FIG. 3 is a block diagram of one exemplary embodiment of an accessory managing portion usable in a programming environment of a metrology system, and one exemplary embodiment of a remote device useable as a remote device reference information programming accessory when connected to the accessory managing portion;

FIG. 4 is a block diagram of one embodiment of an editing portion, including an accessory managing portion and other elements usable in a programming environment of a metrology system according to principles disclosed herein;

FIG. 5 shows one embodiment of user interface features and operations in a programming environment of a metrology system related to adding reference information from a remote accessory according to principles disclosed herein;

FIG. 6 shows one embodiment of user interface features in a programming environment of a metrology system usable to authorize a connection and input from a remote device according to principles disclosed herein;

FIGS. 7A-7C show one embodiment of user interface features and operations usable on a remote device to authorize the remote device and add a set of reference information to a current instruction representation in a metrology system programming environment;

FIG. 8 shows one embodiment of user interface features and operations usable in a programming environment in relation to adding a set of reference information associated with an instruction representation;

FIG. 9 shows a user interface feature related to the persistence of a reference information indicator tag feature in a part program representation window when reference information is associated with a child node instruction representation under a collapsed parent node instruction representation;

FIG. 10 shows a block diagram of one exemplary implementation of various features and operations of an accessory managing portion using web services;

FIG. 11 shows one embodiment of node identification and coordination of operations between windows, applications, or devices, usable in a programming environment in conjunction with various features and operations disclosed herein related to providing reference information associated with an instruction representation in the programming environment; and

FIG. 12 is a flow diagram showing one exemplary embodiment of a method for operating an accessory managing portion of a programming environment of a programmable metrology system according to features and operations disclosed herein.

### DETAILED DESCRIPTION

In contrast to the constraints and deficiencies associated with the dedicated remote devices outlined previously, relatively unskilled users of programmable metrology systems may frequently carry personal computing and/or file storage devices (e.g., tablets or smart phones, or the like) that they are already familiar with. On such devices, they may keep personal notes, files, and/or pictures which help them document and remember programming commands and/or system training, special workpiece and/or setup features, or other considerations related to part programming. Furthermore, such personal computing and/or file storage devices frequently include cameras, Internet browsers, and other devices and programs with which the user is familiar and may prefer to use for generating additional reference information while creating a part program. However, relatively unskilled users lack the capability to connect such familiar personal devices to metrology systems as remote accessories. Furthermore, the programming environments of metrology systems have not included features that facilitate the connection of such devices, nor features that easily attach reference information that they may provide at a particular location in a part program.

Personal mobile or remote devices such as tablets or smart phones or the like have become more versatile and it would be desirable if programmable metrology systems included features such that they could easily be connected to provide the “free,” familiar, readily available functionality of such remote devices to supplement the native operations and programming environment capability of such metrology systems.

As disclosed herein, remote devices not normally associated with a metrology system may be integrated into a programming environment of metrology systems in order to provide additional data that may be used to assist in programming and/or annotating programmed measurement operations, or the like. In particular, such devices may be linked in a configuration with metrology systems such that relatively unskilled users may embed supplementary or reference information in part programs and/or their representation in an editing environment, while creating and/or editing the part programs (e.g., typical values, setup instructions, pictures and/or videos, and/or explanations of programmed instructions or operations, and the like).

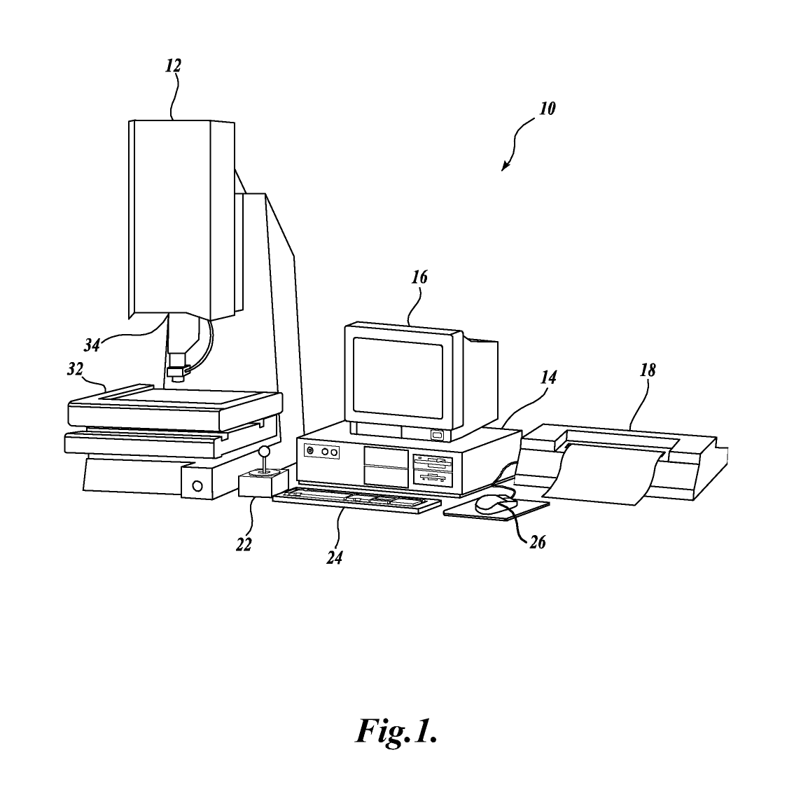

FIG. 1 is a diagram showing various typical components of one exemplary machine vision inspection system 10 usable in accordance with methods described herein. The machine vision inspection system 10 includes a vision measuring machine 12 that is connected to exchange data and control signals (e.g., through a connector or wireless connection) with a controlling computer system 14. The controlling computer system 14 is further connected to exchange data and control signals with a monitor or display 16, a printer 18, a joystick 22, a keyboard 24, and a mouse 26. The monitor or display 16 may display a user interface suitable for controlling and/or programming the operations of the machine vision inspection system 10. It will be appreciated that in various embodiments, a touchscreen tablet or the like may be substituted for and/or redundantly provide the functions of any or all of the computer system 14, the display 16, the joystick 22, a keyboard 24, and the mouse 26.

The controlling computer system 14 may generally consist of any computing system or device such as a personal computer, server computer, minicomputer, mainframe computer, distributed computing environment that include any of the foregoing, and the like. One or more processors may execute software to perform the functions described herein. Processors include programmable general-purpose or special-purpose microprocessors, programmable controllers, application-specific integrated circuits (ASICs), programmable logic devices (PLDs), or the like, or a combination of such devices. Software may be stored in memory, such as random-access memory (RAM), read-only memory (ROM), flash memory, or the like, or a combination of such components. Software may also be stored in one or more storage devices, such as magnetic- or optical-based disks, flash memory devices, or any other type of non-volatile storage medium for storing data. Software may include one or more program modules that include routines, programs, objects, components, data structures, and so on that perform particular tasks or implement particular abstract data types. In distributed computing environments, the functionality of the program modules may be combined or distributed across multiple computing systems or devices and accessed via service calls, either in a wired or wireless configuration.

The vision measuring machine 12 includes a moveable workpiece stage 32 and an optical imaging system 34 that may include a zoom lens or interchangeable lenses. The machine vision inspection system 10 is generally comparable to the QUICK VISION® series of vision systems and the QVPAK® software discussed above, and similar state-of-the-art commercially available systems. The machine vision inspection system 10 is also described in commonly assigned U.S. Pat. Nos. 7,454,053; 7,324,682; 8,111,905; and 8,111,938, each of which is incorporated herein by reference in its entirety.

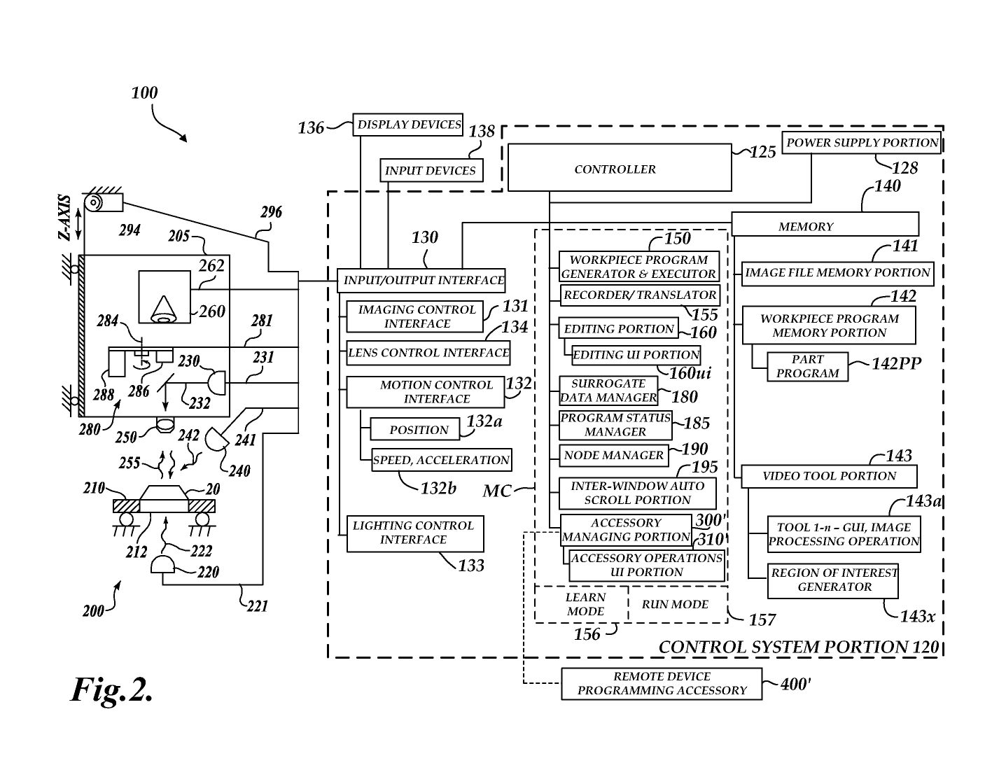

FIG. 2 is a block diagram of a control system portion 120 and a vision components portion 200 of a machine vision inspection system 100 similar to the machine vision inspection system of FIG. 1, and includes features usable in various embodiments according to the principles described herein. As will be described in more detail below, the control system portion 120 is utilized to control the vision components portion 200. As shown in FIG. 2, the vision components portion 200 includes an optical assembly portion 205, light sources 220, 230, and 240, and a workpiece stage 210 having a central transparent portion 212. The workpiece stage 210 is controllably movable along X and Y axes that lie in a plane that is generally parallel to the surface of the stage where a workpiece 20 may be positioned. The optical assembly portion 205 includes a camera system 260, an interchangeable objective lens 250, and may include a turret lens assembly 280 or, alternatively, a fixed or manually interchangeable magnification-altering lens, or the like. The optical assembly portion 205 is controllably movable along a Z axis that is generally orthogonal to the X and Y axes, by using a controllable motor 294.

A workpiece 20, or fixture holding a plurality of workpieces 20, may be placed on the workpiece stage 210. The workpiece stage 210 may be controlled to move such that the interchangeable objective lens 250 moves between locations on a workpiece 20. One or more of the lights may emit respective source light 222, 232, or 242, to illuminate the workpiece 20. The source light is reflected or transmitted as workpiece light 255, which passes through the interchangeable objective lens 250 and the turret lens assembly 280 and is gathered by the camera system 260. The image captured by the camera system 260, is output on a signal line 262 to the control system portion 120. The light sources 220, 230, and 240 may be connected to the control system portion 120 through signal lines or busses 221, 231, and 241, respectively. To alter the image magnification, the control system portion 120 may control rotation of the turret lens assembly 280 through a signal line or bus 281.

The optical assembly portion 205 is movable in the vertical Z axis direction relative to the workpiece stage 210 using a controllable motor 294 that drives an actuator, to move the optical assembly portion 205 to change the focus of the image captured by the camera system 260. The term Z axis, as used herein, refers to the axis that is used for focusing an image. The controllable motor 294, when used, is connected to an input/output interface 130 via a signal line 296.

As shown in FIG. 2, in various exemplary embodiments, the control system portion 120 includes a controller 125, a power supply portion 128, the input/output interface 130, a memory 140, a workpiece program generator and executor 150, a recorder/translator 155, a learn mode portion 156, a run mode portion 157, an editing portion 160, a surrogate data manager 180, a program status manager 185, a node manager 190, an inter-window auto-scroll portion 195, and an accessory managing portion 300′ that may be used to connect to remote device information accessory 400′, as described in greater detail below. Each of these components, as well as the additional components described below, may be interconnected by one or more data/control buses and/or application programming interfaces, or by direct connections between the various elements.

The input/output interface 130 includes an imaging control interface 131, a motion control interface 132, a lighting control interface 133, and a lens control interface 134. The lighting control interface 133 controls, for example, the selection, power, on/off switch, and strobe pulse timing if applicable, for the various corresponding light sources of the machine vision inspection system 100.

The memory 140 includes an image file memory portion 141, a workpiece program memory portion 142 that may include one or more part programs 142PP or the like, and a video tool portion 143. The video tool portion 143 includes video tool portion 143a and other video tool portions, which determine the GUI, image-processing operation, etc., for each of the corresponding video tools. The video tool portion 143 also includes a region of interest (ROI) generator 143x that supports automatic, semi-automatic, and/or manual operations that define various ROIs that are operable in various video tools included in the video tool portion 143.

In general, the memory portion 140 stores data usable to operate the vision system to acquire an image of the workpiece 20 that has desired image characteristics. The memory portion 140 may also store inspection result data, may further store data usable to operate the machine vision inspection system 100 to perform various inspection and measurement operations on the acquired images (e.g., implemented, in part, as video tools), either manually or automatically, and to output the results through the input/output interface 130. The memory portion 140 may also contain data defining a user interface operable through the input/output interface 130.

The signal lines or busses 221, 231, and 241 of the lights, the signal line 262 from the camera system 260, and the signal line 296 from the controllable motor 294 are all connected to the input/output interface 130. In addition to carrying image data, the signal line 262 may carry a signal from the controller 125 that initiates image acquisition.

One or more display devices 136 (e.g., the display 16 of FIG. 1) and one or more input devices 138 (e.g., the joystick 22, keyboard 24, and mouse 26 of FIG. 1) can also be connected to the input/output interface 130. The display devices 136 and input devices 138 can be used to display a user interface, which may include various user interface features that are usable to perform inspection operations, and/or to create and/or modify part programs, to view the images captured by the camera system 260, and/or to directly control the vision system components portion 200. In various embodiments, the display devices 136 and input devices 138 are used to present various user interface features usable to allow rapid, efficient, intuitive, and flexible editing of part programs on the machine vision inspection system 100.

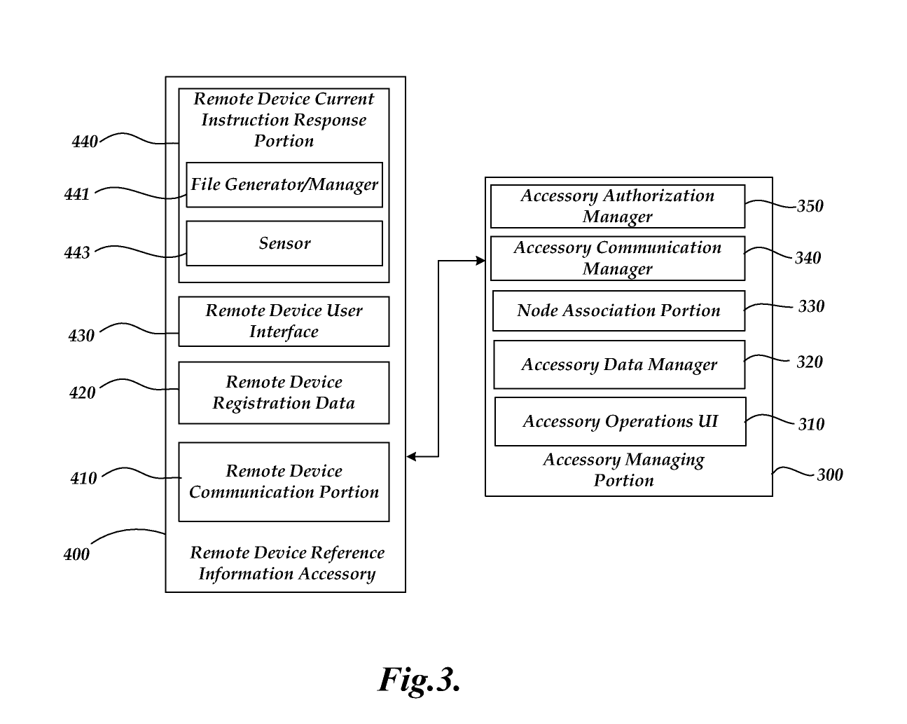

The workpiece program generator and executor 150, recorder/translator 155, learn mode portion 156, run mode portion 157, editing portion 160, surrogate data manager 180, program status manager 185, node manager 190, inter-window auto scroll portion 195, and accessory managing portion 300′ may in one embodiment all be considered to be part of a general machine controller block MC that is linked to the controller 125. Additionally, the remote device information accessory 400′ described in greater detail with reference to FIGS. 3-9 may be linked to the controller 125 (e.g., through the accessory managing portion 300′). The remote device information accessory 400′ may be considered to be an accessory outside of, but communicating to inter-operate with, the control system portion 120 in some embodiments. The workpiece program generator and executor 150 is responsible for creating and executing part programs. It will be appreciated that the terms “workpiece program” and “part program” may be used interchangeably herein.

In accordance with the operations of the workpiece program generator and executor 150, in various exemplary embodiments, when a user utilizes the machine vision inspection system 100 to create a part program for the workpiece 20, the user generates part program instructions either by explicitly coding the instructions automatically, semi automatically, or manually, using a workpiece programming language, and/or by generating the instructions by operating the machine vision inspection system 100 in a learn mode (e.g., as controlled by the learn mode portion 156) to provide a desired image acquisition training sequence. For example, a training sequence may comprise positioning a workpiece feature in the field of view (FOV), setting light levels, focusing or autofocusing, acquiring an image, and providing an inspection training sequence applied to the image (e.g., using video tools). The learn mode operates such that the sequence(s) are captured or recorded and converted to corresponding part program steps (i.e., instructions). These part program steps, when the part program is executed in a run mode (e.g., as controlled by the run mode portion 157), will cause the machine vision inspection system to reproduce the trained image acquisition and inspection operations to automatically inspect a workpiece or workpieces matching the workpiece used when creating the part program.

The recorder/translator 155 is utilized for translating machine operations into part program code. In other words, if a user performs an action (e.g., such as altering a video tool that is used to measure a feature on a workpiece) an instruction is generated that is translated into a machine readable language, and a reverse translation may also be performed. As will be described in more detail below, in certain embodiments disclosed herein, certain instructions in a part program may also be translated into instruction representations in a user interface. In some embodiments, the part program instructions may be written in a mark-up-type language code. In one specific example embodiment, the mark-up language code may be XML code. The editing portion 160 provides or activates various operations and user interface features related to editing a part program within an editing user interface portion 160ui, which may include a part program representation window as described in greater detail below.

The surrogate data manager 180 need not be present, but may be used in combination with some embodiments. Briefly, the surrogate data manager 180 links to surrogate data, which may be recorded in a part program. In certain implementations, the surrogate data manager 180 is responsible for obtaining the surrogate data from an output where it would normally be generated, and providing the surrogate data to be written into the part program such that the program operation may be rapidly executed in a simulation mode using the surrogate during learn mode operations, in order to support editing operations. The surrogate data manager 180 is described in greater detail in commonly assigned U.S. patent application Ser. No. 13/297,232 (the '232 application), which is hereby incorporated herein by reference in its entirety.

The program status manager 185, in one embodiment, manages whether programs are protected or unprotected. In one implementation, an unprotected part program may include stored surrogate data, while a protected part program has surrogate data removed. In one example embodiment, protected programs are programs for which the editing process has been completed, such as may be utilized in a factory in a run mode.

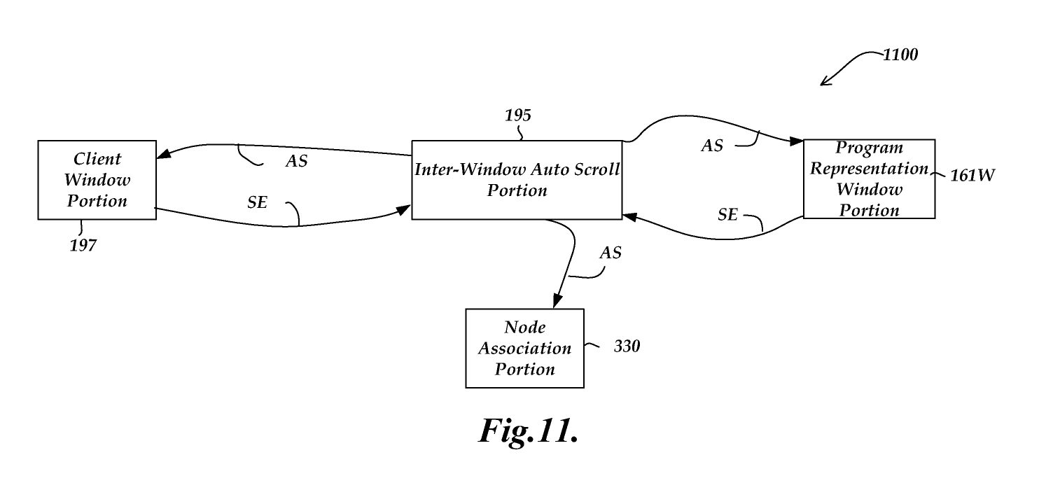

In one embodiment, the node manager 190 is responsible for managing node numbers that are assigned to nodes in a part program. In one implementation, within a representation of a part program, each of the instruction representations is assigned a node number. In certain implementations, an organizational tree structure may be utilized wherein there are parent nodes and child nodes. In certain implementations, every line of a part program representation that is generated by the recorder/translator 155 is assigned a node number, or a guaranteed unique identifier, or the like by the node manager 190. As described in greater detail in commonly assigned U.S. patent application Ser. No. 13/676,061 (the '061 application), which is hereby incorporated herein by reference in its entirety, in some embodiments the inter-window auto scroll portion 195 may utilize the node numbers assigned by the node manager 190 to display associated part program elements and corresponding editing functions in different windows at the same time. In other words, if a user wishes to see which measurements of a workpiece are related to which instruction representations and coded instructions in a part program, the inter-window auto scroll portion 195 will automatically scroll in the respective windows to the relevant lines in the part program representation and/or coded instructions that correspond to the relevant node number. One exemplary method and/or implementation of inter-window communication is described below, with reference to FIG. 11. In some embodiments, the accessory management portion 300′ may interoperate with the node manager 190 and/or the inter-window auto scroll portion 195 using an analogous method, such that the accessory operations user interface portion 310′ and/or the remote device reference information accessory 400′ may receive and/or send active node number information and/or the associated part program instruction representations, or the like, according to principles and operations disclosed herein.

Regarding FIG. 2, many features of FIG. 2 may be further understood based on the descriptions of their analogous or substantially similar counterparts which are similarly depicted, described and/or referenced elements in the previously incorporated co-pending '232 and '061 applications.

FIG. 3 is a block diagram of one exemplary embodiment of an accessory managing portion 300 usable in a programming environment of a metrology system (e.g., as the accessory managing portion 300′ shown in FIG. 2), and one exemplary embodiment of a remote device useable as a remote device reference information programming accessory 400 (e.g., as the remote device reference information accessory 400′ shown in FIG. 2) when connected to the accessory managing portion 300. In the embodiment shown in FIG. 3, the accessory managing portion 300 comprises an accessory operations user interface 310, an accessory data manager 320, a node association portion 330, an accessory communication manager 340, and an accessory authorization manager 350. The remote device reference information accessory 400 comprises a remote device communication portion 410, remote device registration data 420, a remote device user interface 430, and a remote device current instruction response portion 440, which in the embodiment shown in FIG. 3 may include a remote device file generator/manager 441 and/or a remote device sensor 443.

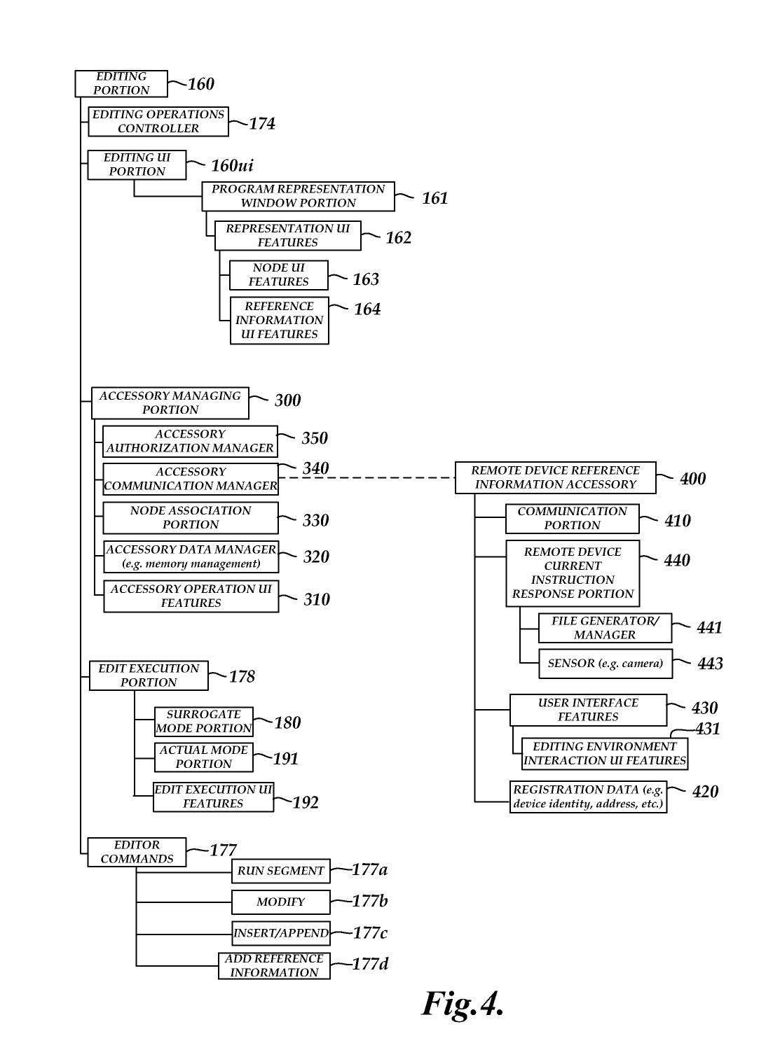

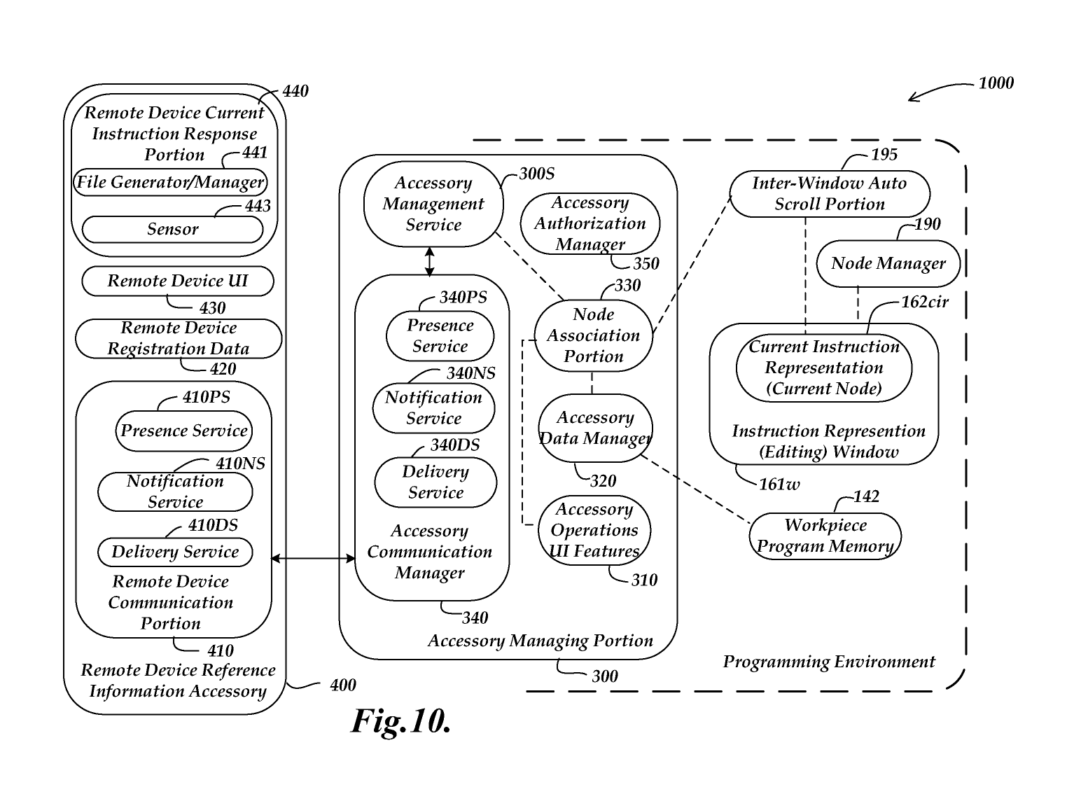

Generally speaking, the accessory managing portion 300 is configured to provide relatively unskilled users with the capability to connect familiar personal devices to a metrology system as remote accessories to be used while creating and editing part programs. This is accomplished, for example, by providing user interface features and operations which facilitate the connection of such devices, and features that allow users to easily attach reference information from such accessories at a particular location in a part program. In some embodiments, the accessory managing portion 300 is configured such that ease of connection and ease-of-use of the remote device reference information accessory 400 within a metrology system programming environment is particularly emphasized. The accessory operations user interface 310 may include commands, dialog boxes, and other display elements to support this emphasis, for example as outlined below with reference to an exemplary embodiment shown in FIGS. 4-9. The accessory communication manager 340 may include device communication circuits and/or routines to support this emphasis, for example, as outlined below with reference to an exemplary embodiment shown in FIG. 10. The accessory communication manager 340 may manage communications between the programming environment and the remote device reference information accessory 400, for example, to support the operations of the accessory authorization manager 350 and the accessory data manager 320, and so on.

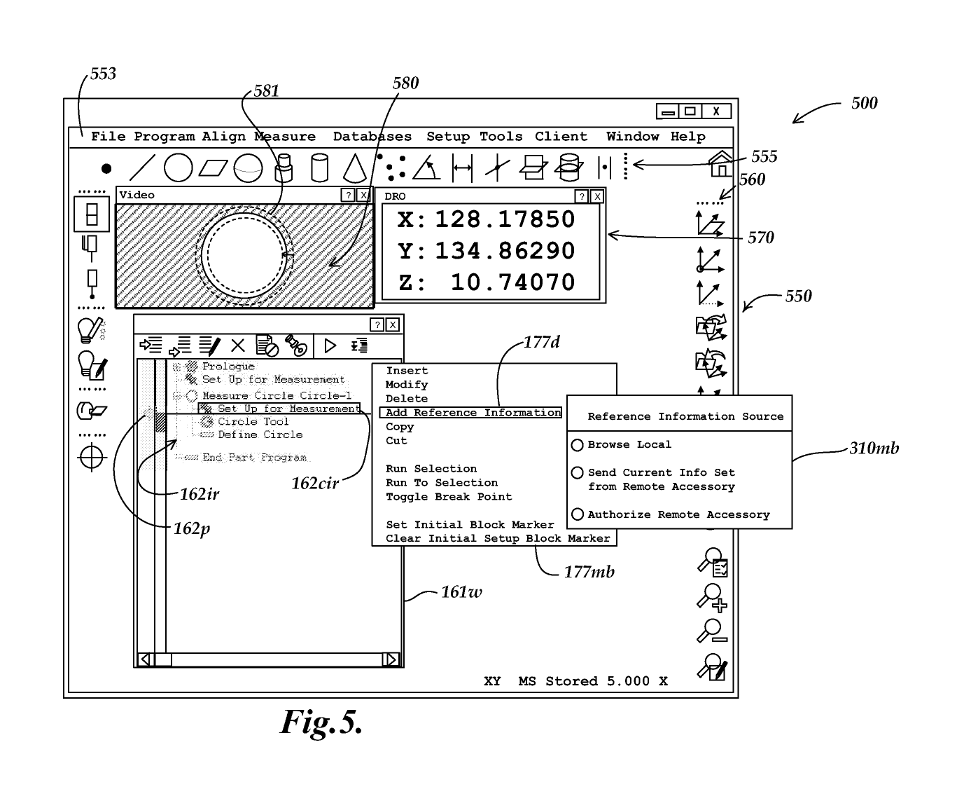

The accessory authorization manager 350 may include authorization routines and related user interface features that register a trusted remote device in relation to a metrology system programming environment, for example, as outlined below with reference to an exemplary embodiment shown in FIGS. 5-7. The accessory data manager 320 may operate in cooperation with the node association portion 330 in order to associate particular reference information from the remote device reference information accessory 400 with a particular part program instruction representation (e.g., a current part program instruction representation) in the programming environment, and store it in a manner that supports that association.

The node association portion 330 is configured to support the operations of other elements of the accessory managing portion 300. In one embodiment, the node association portion 330 may interoperate with the node manager 190 and/or the inter-window auto scroll portion 195 and/or use an analogous method, such that various elements of the accessory managing portion 300 and the remote device reference information accessory 400 may exchange current node number information and/or the associated part program instruction representations, or the like, according to principles and operations disclosed herein. The node manager 190 is described in greater detail in the previously incorporated '232 and '061 applications, and one exemplary embodiment of the inter-window auto scroll portion 195 is outlined below with reference to FIG. 11.

Generally speaking, the remote device reference information accessory 400 may be any device capable of generating and/or storing reference information that is relevant to a metrology system part program, and that is connectable to the accessory managing portion 300 (e.g., through a network, and/or wireless connection such as Bluetooth or WiFi, or the like). However, as previously outlined, users of programmable metrology systems may frequently carry personal computing and/or file storage devices (e.g., tablets or smart phones, or the like) which they are already familiar with, and which are not dedicated or specially configured accessories of a metrology system. Such personal computing and/or file storage devices frequently include cameras, Internet browsers, and other devices and programs with which the user is familiar with and may prefer to use for generating additional reference information while creating a part program. In some embodiments, such devices may be configured to include a locally resident application that is customized to interact with a particular type of metrology system in the manner disclosed herein. However, in other embodiments, in order to facilitate easy connection and/or ease-of-use, at least prior to authorizing a remote device for connection to the programming environment, the remote device need not include a stored program or application customized to interact with the programming environment of the programmable metrology system. In some embodiments, an Internet browser and/or other applications previously resident on the remote device (and not normally associated with a metrology system) may provide all of the functions required in order to provide the features and operations disclosed herein, as outlined below with reference to an exemplary embodiment shown in FIGS. 4-10, for example.

The remote device communication portion 410 may include device communication circuits and/or routines, for example, as outlined below with reference to an exemplary embodiment shown in FIG. 10. The remote device communication portion 410 may provide and/or manage communications to and from the remote device reference information accessory 400 to support the various features and operations of the accessory managing portion 300 disclosed herein.

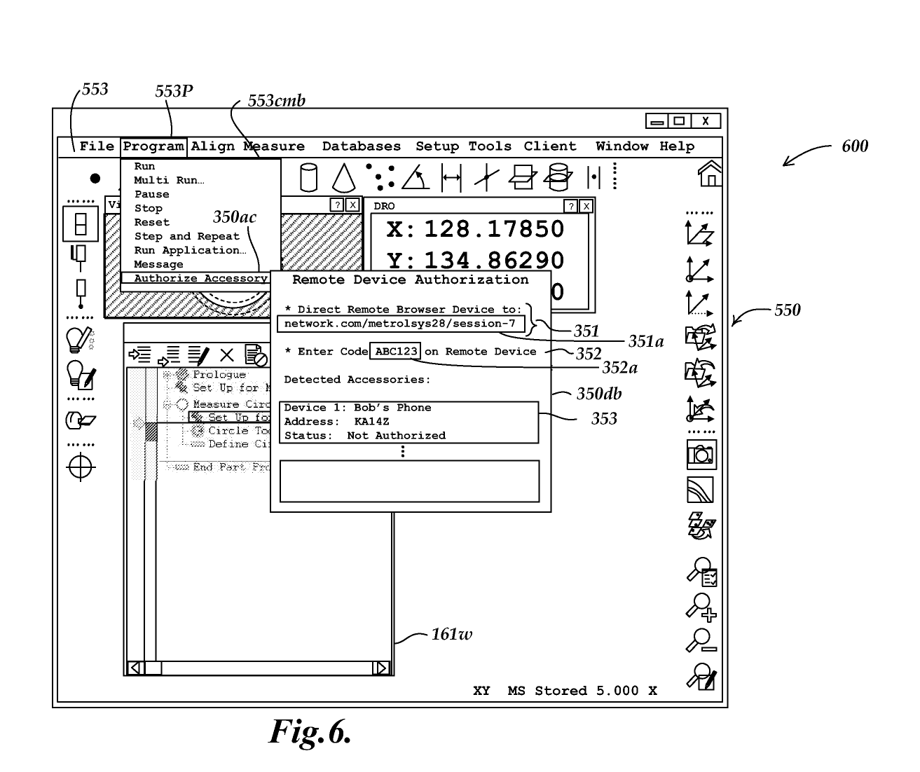

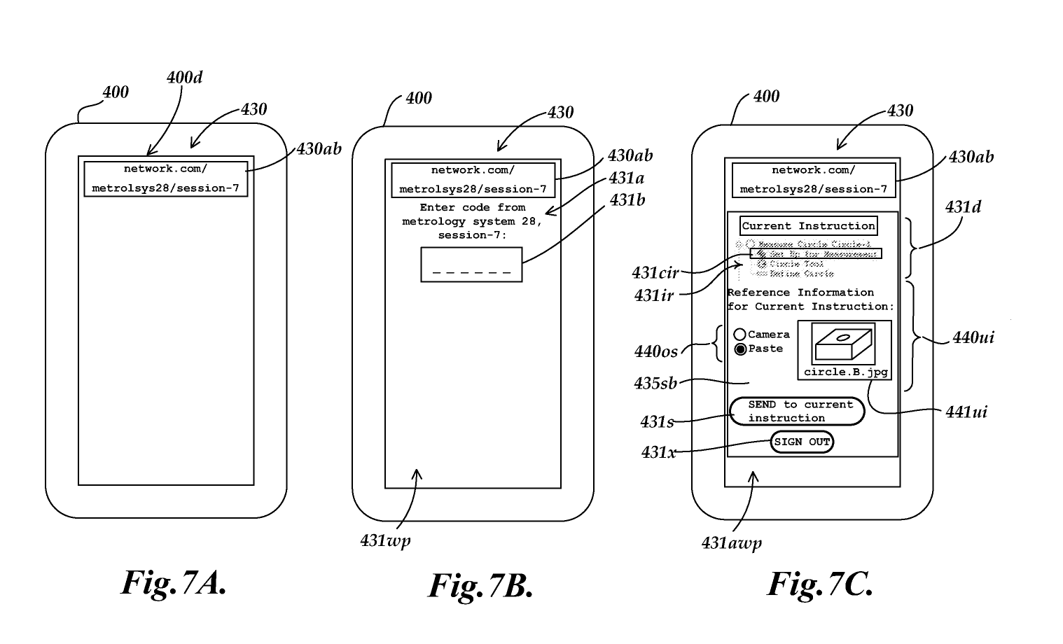

The remote device registration data 420 may include information and operations that identify the remote device reference information accessory 400 and support various features and operations of the accessory authorization manager 350 disclosed herein, for example, as outlined below with reference to an exemplary embodiment shown in FIGS. 6-7.

The remote device current instruction response portion 440, which may include a remote device file generator/manager 441 and/or a remote device sensor 443, may operate to prepare a particular set of reference information on the remote device reference information accessory 400, to be associated with a with a particular part program instruction representation. The remote device sensor 443 may comprise one or more of a camera, a microphone, a temperature sensor, vibration sensor, compass, GPS, bar code sensor, an RFID sensor, for example, in various embodiments. Once prepared, the set of reference information may be sent to the programming environment (e.g., through the accessory managing portion 300) in association with that particular part program instruction representation (e.g., a current part program instruction representation), for example, as outlined below with reference to FIGS. 7, 8, 10, and 11. The remote device user interface 430 may include commands, dialog boxes and other display elements to support interaction with the programming environment (e.g., through the accessory managing portion 300), for example, as outlined below with reference to an exemplary embodiment shown in FIGS. 4-8, 10 and 11. In some embodiments, the remote device user interface 430 may comprise or consist of webpage features, interactive webpage features or the like, and/or features of an Internet browser and/or other applications previously resident on the remote device (and not normally associated with a metrology system) in order to provide the features and operations disclosed herein. However, such embodiments are exemplary only and not limiting. In some embodiments, applications including user interface features may be downloaded to the remote device reference information accessory 400 for execution.

FIG. 4 is a block diagram of one exemplary embodiment of an editing portion 160 (e.g., usable as the editing portion 160 shown in FIG. 2), including an accessory managing portion 300, which may be linked to a remote device reference information accessory 400, and other elements usable in a programming environment of a metrology system according to principles disclosed herein. As shown in FIG. 4, the editing portion 160 includes an editing operations controller 174, an editing user interface portion 160ui, an editor commands portion 177, and an edit execution portion 178. The editing operation controller 174 controls the operations for the editing functions, and the editing user interface portion 160ui provides the user interface features for the editing functions. The editing user interface portion 160ui includes a program representation window portion 161, which includes representation user interface features 162, which includes node user interface features 163, and reference information user interface features 164. In one embodiment, a part program representation in the program representation window may be provided in a tree structure. The representation user interface features 162 provides features such as an insertion pointer that may change color depending on the state of the context and how the context was obtained (e.g., whether the context was produced from surrogate data, by an actual run, etc.) With regard to the node user interface features 163, in one embodiment, these may include features such as icons or broken icons, and color highlights, so as to indicate if an instruction representation “node” is the active current node (that is, so as to indicate that is the target to be affected by current actions in the user interface), and so on, etc. Some exemplary embodiments of various features of the editing user interface portion 160ui and the program representation window portion 161, including some exemplary reference information user interface features 164, are described in more detail below with respect to FIGS. 5, 6, 8, and 9, for example.

The edit execution portion 178 is responsible for various execution modes during an editing process, and includes a surrogate mode portion 180, an actual mode portion 191, and an edit execution user interface features portion 192. When the surrogate mode portion 180 operates a surrogate execution mode, surrogate data is utilized for generating context for the continuing editing operations. The actual mode portion 191 includes operations that are more traditionally performed by prior machine vision systems. The actual mode portion 191 may be called by the surrogate mode portion 180 for performing actual machine operations when appropriate. The edit execution user interface features 192 provide user interface features for the execution of the editing functions (e.g., indications as to the status of various execution operations, such as color codes indicating what portions of a part program have utilized surrogate data, or have been run through an actual execution, etc.) The elements of the edit execution portion 178 may be further understood based on the descriptions of their analogous or substantially similar counterparts that are similarly depicted, described, and/or referenced elements in the previously incorporated co-pending '232 and '061 applications.

The editor commands 177 includes a run segment portion 177a, a modify portion 177b, and an insert/append portion 177c, described in detail in the '232 application, as well as an add reference information portion 177d which, in one embodiment, may operate according to principles described in greater detail below (e.g., with reference to FIGS. 5-9).

The accessory managing portion 300 comprises an accessory operations user interface 310, an accessory data manager 320, a node association portion 330, an accessory communication manager 340, and an accessory authorization manager 350. The accessory managing portion 300 and its various elements have been previously outlined with reference to FIG. 3 and are further described with reference to following figures, and need not be further described here. As shown in FIG. 4, a remote device reference information programming accessory 400 may be linked to communicate with the accessory managing portion 300 through the accessory communication manager 340 (e.g., as described below with reference to FIGS. 5-7 and FIG. 10), and may thereby become an accessory part of the programming environment provided by the editing portion 160. The remote device reference information accessory 400 may comprises a remote device communication portion 410, remote device registration data 420, a remote device user interface 430, and a remote device current instruction response portion 440, which in the embodiment shown in FIG. 4 may include a remote device file generator/manager 441 and/or a remote device sensor 443. The remote device reference information accessory 400 and its various elements have been previously outlined with reference to FIG. 3 and are further described with reference to following figures, and need not be further described here.

FIG. 5 is a diagram 500 of a first state of a learn mode user interface 550 comprising one embodiment of a programming environment of a metrology system, including features related to adding reference information from a remote accessory according to principles disclosed herein. In the embodiment shown in FIG. 5, the first state of the programming environment includes a menu bar 553, a toolbar 555, a toolbar 560, a stage position display 570, a field of view display 580, a part program representation window 161w (also referred to as an editing window 161w in some contexts herein), a command menu box 177mb, and a reference information source menu box 310mb. The part program representation window 161w includes a set of part program instruction representations 162ir, including a current instruction representation 162cir, which may be indicated as the currently active instruction representation by the position of the pointer 162p. The current instruction representation 162cir is illustrated with a surrounding box for clarity. The toolbar 555 comprises various user tools (e.g., measurement video tools) arranged horizontally in the upper portion of the user interface 550. The toolbar 560 comprises user tools (e.g., alignment and magnification tools) arranged vertically on the right hand portion of the user interface 550. The stage position display 570 displays X, Y, and Z coordinates indicating a position of the stage 32. The field of view display 580 may display a real-time video image of a field of view of the machine vision inspection system 100 as imaged by the camera 260, and for reference, schematically displays in dashed outline the location where a circle tool region of interest 581 would appear as it is defined and recorded by a user (e.g., corresponding to the “circle tool” instruction representation included in the instruction representations 162ir). The user interface 550 has counterpart elements described in the in the previously incorporated '232 and '061 applications, and its various elements may be further understood based on description in those references.

In the first state of the programming environment shown in FIG. 5, the user has previously selected the instruction representation 162cir “Set up for Measurement,” making it the current instruction representation, and entered a user input that has caused the command menu box 177mb to appear in association with that instruction representation (e.g., by “right clicking” a mouse button while hovering over instruction representation 162cir). The user has then selected the “Add Reference Information” command 177d and entered a user input that has caused the reference information source menu box 310mb to appear in association with that command (e.g., by using the “right click” operation outlined above). In the embodiment shown in FIG. 5, the reference information source menu box 310mb includes buttons to select one of: “Browse Local” (e.g., for using a file browser to search for a desired reference information file located in the local metrology system); “Send Current Information Set from Remote Accessory” (e.g., equivalent to the “SEND to current instruction” button 431s located at the remote device information accessory 400, described below with reference to FIG. 7C); and, “Authorize Remote Accessory” (e.g., when it is desired to obtain reference information from a remote device, such as a personal device of the user, which is not yet authorized to send reference information to the programming environment). The user may select the “Authorize Remote Accessory” operation from the menu as one method of activating remote device authorization, as described below with reference to FIG. 6.

FIG. 6 is a diagram 600 of a second state of the learn mode user interface 550 comprising one embodiment of a programming environment of a metrology system, including features related to authorizing a connection and input from a remote device reference information accessory according to principles disclosed herein. In the second state of the programming environment shown in FIG. 6, the user has selected the “Program” menu item 550P on the menu bar 553, causing the drop-down command menu box 553cmb to appear, and then selected the “Authorize Accessory” command 350ac, which has caused the “Remote Device Authorization” dialog box 350db to appear. In the embodiment shown in FIG. 6, the remote device authorization dialog box 350db includes instructions 351 and 352, to be read and performed by the user. In the state of the user interface shown in FIG. 6, it is assumed that the user has connected a remote device (e.g., their personal smart phone, or tablet, or the like) to a network that includes the metrology system which is displaying user interface 550. For example, in various embodiments, the remote device may be connected to the Internet, an intranet, a wired network, or a wireless network (e.g., using Wi-Fi), or to the metrology system itself (e.g., using a Bluetooth connection), or the like, according to known methods. In the embodiment shown in FIG. 6, it is assumed that the remote device is connected to an intranet, as is the metrology system that is displaying the user interface 550. Thus, in the exemplary method described here, the displayed instruction 351 instructs the user to enter a particular address 351a, associated with the metrology system, in the address bar of their Internet browser on the remote device (e.g., as shown in FIG. 7A). In response to the user entering that address on their remote device, the accessory managing portion 300 is notified of the presence and/or address of the remote device, and is configured to transmit a webpage to be displayed on the remote device (e.g., as shown in FIG. 7B). Communication between the accessory managing portion 300 and the remote device may be implemented using methods outlined below with reference to FIG. 10, for example. In the example described here, the displayed instruction 352 instructs the user to enter particular authorization code 352a (generated by the accessory managing portion 300), into a code entry box included in the transmitted webpage (e.g., the code entry box 431b, shown in FIG. 7B). This is easily accomplished because the user may generally be present at the metrology system, with their remote device in hand.

In various embodiments, the remote device authorization dialog box 350db may include one or more remote device status boxes 353 for remote devices detected by the metrology system and/or the accessory managing portion 300, which may display respective remote devices (e.g., their identity and/or their device address on the network) and their authorization status, and the like. The remote device status box 353 may be particularly valuable, for example, when a remote device connects directly to the metrology system through a Bluetooth connection, or the like.

FIGS. 7A-7C show first, second, and third states, respectively, of one embodiment of user interface features and operations usable on a remote device reference information accessory 400 to authorize that remote device for connection to interact with a metrology system programming environment and add a set of reference information to a current instruction representation in the programming environment. FIG. 7A shows a remote device reference information accessory 400 (e.g., a smart phone) including a touchscreen display 400d, which provides a user interface 430 including an Internet browser interface that provides an address bar 430ab. In the first state shown in FIG. 7A, it is assumed that the user has connected the remote device 400 to the network that includes the metrology system that is displaying user interface 550 in FIG. 6, and has followed the displayed instruction 351 shown in FIG. 6, which instructs the user to enter the particular address 351a associated with the metrology system, in the address bar of their Internet browser on the remote device.

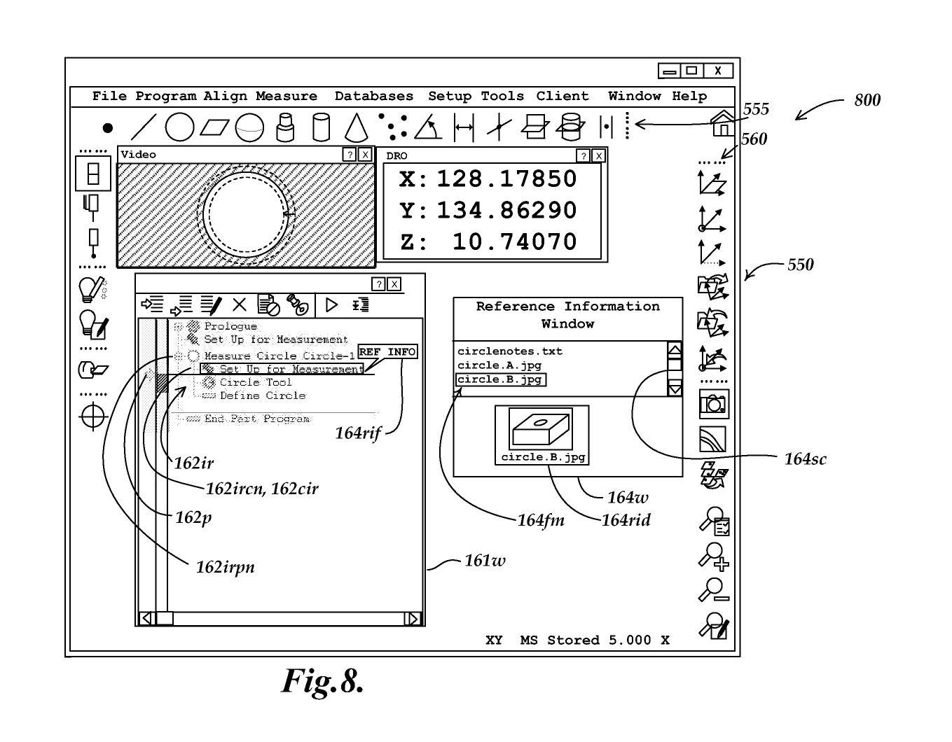

FIG. 7B shows a second state of the remote device 400, after the user has entered, and been connected to, the particular address 351a, as outlined in FIG. 7A. In response, the accessory managing portion 300 is notified of the presence and/or address of the remote device 400, and transmits a webpage 431wp to be displayed on the remote device as shown in FIG. 7B. In the example described here, the webpage 431wp includes an instruction 431a, which instructs the user to enter the particular authorization code 352a (shown in FIG. 6) into the code entry box 431b (such that it is transmitted back to the accessory authorization manager 350 of the accessory managing portion 300). This is easily accomplished because the user may generally be present at the metrology system, with their remote device in hand, observing the displays of each. The accessory authorization manager 350 is configured to compare the code received from a remote device 400 to the particular authorization code 352a. If the codes match, the accessory authorization manager 350 authorizes the remote device 400 to interact with the programming environment of the metrology system to implement the various operations and features disclosed herein (e.g., as described with reference to FIGS. 7C and 8, and so on). This is one exemplary method of providing a secure method for the local user, to connect their local personal device exclusively to the local metrology system, despite the presence of other remote devices and/or metrology systems on a factory intranet, or network, or the like.

FIG. 7C shows a third state of the remote device 400, after the remote device 400 has been authorized to interact with the programming environment of the metrology system through the accessory managing portion 300. Once authorized, the accessory managing portion 300 may transmit one or more additional “authorized” webpages 431awp to the remote device 400. In the embodiment shown in FIG. 7C, the authorized webpage 431awp includes a current instruction representation indicating portion 431d, a current instruction response portion 440ui, a “SEND to current instruction” button 431s, and a sign out button 431x, which may be used to disconnect the remote device from the accessory managing portion 300 and/or terminate its authorization. In the embodiment shown in FIG. 7C, the current instruction representation indicating portion 431d includes a current instruction representation indication 431cir comprising an image, re-creation, or other representation of the (currently active) current instruction representation in the programming environment (e.g., the current instruction representation 162cir shown in the editing window 161w in FIG. 5), as well as surrounding instruction representations 431ir. The current instruction representation indicating portion 431d may be frequently updated by the accessory managing portion 300, to reflect any changes in the (currently active) current instruction representation in the programming environment of the metrology system. The illustrated form of the current instruction representation indicating portion 431d is exemplary only and not limiting. In other embodiments, the current instruction representation indication on the remote device 400 may simply be the reproduction of only the current instruction representation, or its node number (which may also be displayed in the programming environment), or the like, in any form that increases the user's visibility of the target node for the reference information that is to be provided by the remote device 400. Furthermore, in some embodiments, the current instruction representation indication on the remote device 400 may simply be omitted, because the current instruction representation is indicated in the programming environment itself, and the user can see the display of both devices. However, such embodiments may be somewhat less efficient for the user.

In the embodiment shown in FIG. 7C, the current instruction response portion 440ui includes operation selection buttons 440os, and a reference information confirmation portion 441ui. The operation selection buttons 440os include a camera selection button and a paste button. In this example, it is assumed that if a desired reference information file already exists on the remote device 400, then the user may simply use the native programs or applications of the remote device to locate and copy, or link to, that reference information file (that is, the user may use other capabilities of the remote device by temporarily minimizing the webpage 431awp, for example). In such a case, once the file is copied or linked to the remote device clipboard or the like, then upon returning to the webpage 431awp, the paste button may be operated to paste the file or link to a list of reference information files associated with the current instruction representation in the remote device 400. The reference information files included in that list may be represented in the display of the reference information confirmation portion 441ui (e.g., as a list of filenames, thumbnail images, or icons, or the like). The SEND to current instruction button 431s may be used any time to send the data corresponding to the set of reference information in the file list to the accessory management portion 300. Then the accessory data manager 320 may associate that particular received set of reference information accessory 400 with the current part program instruction representation, and store it in a manner that supports its association with the part program and the current part program instruction representation and/or its underlying part program instruction(s). It will be appreciated that various operations outlined immediately above may be associated with the previously discussed file generator/manager 441. It will be appreciated that if a desired reference information file does not already exist on the remote device 400, and an image is desired as a reference information file, then the camera button of the element 440os, may be operated to minimize the webpage 431awp and/or access image acquisition and storage features that already exist on the remote device 400. The resulting image may then be treated as a reference information file, as outlined above. Of course, if other sensor capabilities exist in the remote device 400, these may be accessed and used to provide reference information in an analogous manner.

In some embodiments, the features and operations of the remote device 400 outlined above with reference to FIGS. 7A-7C may comprise, or consist exclusively of, web page features, interactive web page features or the like, and/or features that may be implemented using an Internet browser and/or other applications previously resident on the remote device (and not normally associated with the metrology system). As such, an unskilled user may easily use a personal device as a remote device reference information accessory 400, with the highly desirable benefits of no special training requirements and with minimal disruption to their personal device. However, such embodiments are exemplary only and not limiting. In some embodiments, applications including user interface features may be downloaded to the remote device reference information accessory 400 for execution.

FIG. 8 is a diagram 800 of a third state of the learn mode user interface 550 comprising one embodiment of an programming environment of a metrology system, including features related to adding a set of reference information associated with a current instruction representation. In the third state of the programming environment shown in FIG. 8, the user has performed the operations outlined above with reference to FIGS. 5, 6, and 7A-7C, including sending a set of reference information from the remote device 400 to the accessory managing portion 300, and storing it in the metrology system in a manner that supports its association with the part program and the current instruction representation (and/or its corresponding underlying part program instruction). In particular, in the example shown in FIG. 8, upon completion of the operation of storing the set of reference information associated with the current instruction representation 162cir, reference information indicator or flag 164rif (a user interface feature) is “attached” proximate to the current instruction representation 162cir. The attachment of the flag 164rif proximate to that particular instruction representation will persist when it is no longer the current instruction representation, and/or when it is scrolled in and out of view in the editing window 161w, or the like. In the example shown in FIG. 8, the user has performed an operation that causes a reference information window 164w to be displayed (e.g., by clicking on the flag 164rif). The reference information window 164w may include a file list or menu 164fm corresponding to the particular set of reference information files associated with the reference information indicator 164rif and/or its associated instruction representation. In the embodiment shown in FIG. 8, the reference information window 164w further includes a scrollbar control 164sc for the file list or menu 164fm, and a reference information display portion 164rid which displays the contents of a file selected from the file list or menu 164fm. The reference information window 164w may be resized, moved, minimized, closed, etc., according to known methods. Alternatively, the reference information window 164w may be omitted, and reference information files may be automatically opened in appropriate default programs according to known methods.

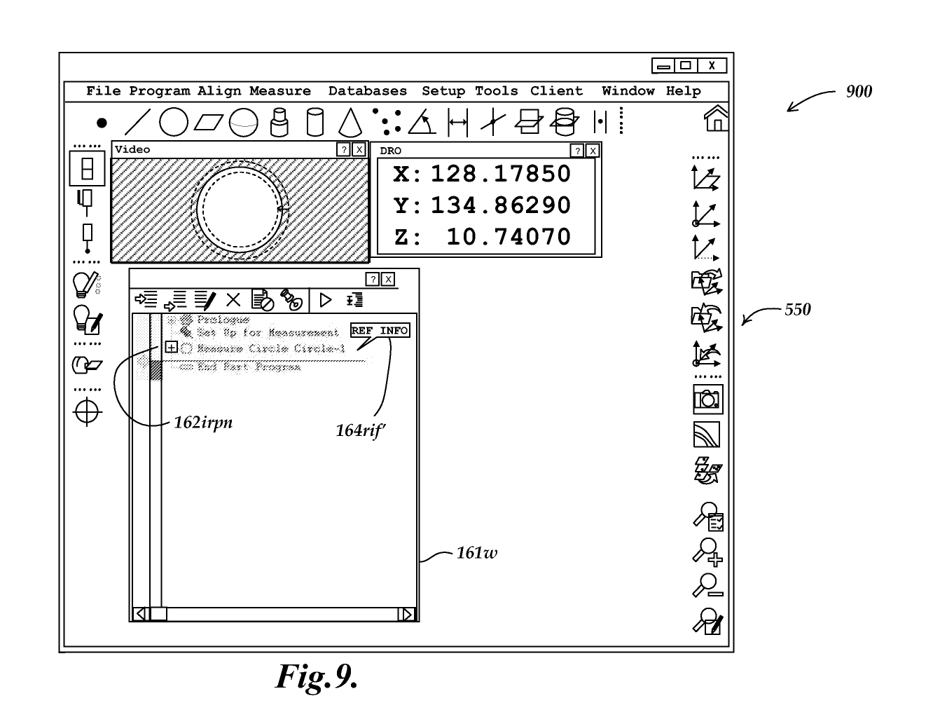

FIGS. 8 and 9 together illustrate user interface features associated with one embodiment of the reference information indicator or flag 164rif. As shown in FIG. 8, reference information indicator 164rif is associated with the instruction representation 162cir, which is a child node 162ircn of the parent node instruction representation 162irpn (e.g., the “set up for measurement” operations are sub operations of the “measure circle circle-1” operations). In the diagram 900 of a fourth state of the learn mode user interface 550 shown in FIG. 9, the user is clicked on the +/− icon shown in front of the parent node instruction representation 162irpn, which has collapsed the display of its child nodes such that they are hidden. However, it may be advantageous for a user to know that reference information is available in association with a collapsed or hidden child node. Therefore, in various embodiments, when a reference information indicator 164rif is associated with a collapsed or hidden child node, it is displayed as a temporary reference information indicator 164rif attached in association with its parent node, for example, as illustrated in FIG. 9. In various embodiments, clicking on the temporary reference information indicator 164rif may cause the associated set of reference information to be displayed as previously outlined, and/or may cause the hidden child node and its associated reference information indicator 164rif to be expanded and displayed.

FIG. 10 shows a block diagram 1000 of one exemplary implementation of various features and operations of an accessory managing portion (e.g., the accessory managing portion 300) using web services.

Generally speaking, a web service is a collection of protocols and standards used for exchanging data between applications or systems. Software applications written in various programming languages, running on various platforms, can use web services to exchange data over computer networks (e.g., like the Internet), in a manner similar to inter-process communication for a single computer. This interoperability is due to the use of open standards (e.g., TCP/IP, HTTP, Java, HTML, and XML). As is known, a web service may be self-describing via common XML grammar, and may be discoverable over a network via a simple find mechanism. For example, a client invokes a web service by sending an XML message, then waits for a corresponding XML response. A basic web service platform is XML+ HTTP. Standard web services may work using the following known components, for example: Simple Object Access Protocol (SOAP); Universal Description, Discovery and Integration (UDDI); Web Services Description Language (WSDL). The design and use of web services is known to software developers, and may be implemented based on known techniques by those who are skilled in the art related to providing a programming environment for a metrology system. Thus, it will be appreciated that the features and operations described below with reference to FIG. 10, as well as other features and operations disclosed herein, may be implemented using known web service programming and operation methods, which need not be described in detail here.

FIG. 10 shows the previously described remote device reference information accessory 400, accessory managing portion 300, and a few elements of the previously described programming environment that are relevant to the present description, including the node manager 190, instruction representation (or editing) window 161w, and workpiece program memory 142. In the embodiment shown in FIG. 10, the previously described remote device communication portion 410 may comprise web service elements including a presence service 410PS, a notification service 410NS, and a delivery service 410DS. Similarly, the previously described accessory communication manager 340 may comprise web service elements including a presence service 340PS, a notification service 340NS, and a delivery service 340DS. The previously described accessory managing portion 300 may comprise web service elements including an accessory management service 300S.

Following is one representative example of operations in accordance with the present invention, using Web services. It will be understood that this example is only representative, and not limiting. In operation, the remote device 400 establishes a connection to a network that is also connected to the metrology system and/or the programming environment, including the accessory managing portion 300. The remote device 400 may then contact the presence service 340PS of the accessory communication manager 340. The presence service 340PS provides information to the accessory management service 300S, and therefore the remote device 400 contacts the presence service 340PS to supply information about the remote device 400 (e.g., so that the accessory management service 300S can supply webpage formats and other data to the remote device 400 in a compatible format, and so on). The remote device 400 notifies the presence service 340PS that it is connected to the network. The remote device 400 may bundle its device registration information into a SOAP message, for example, and may include useful information such as its interface or display characteristics, and the like. The SOAP message may be sent to the presence service 340PS as the body of an HTTP POST request, for example. The presence service 340PS and/or the accessory management service 300S may unpack the SOAP request and convert the information into data, instructions, or commands that the other elements of the accessory managing portion 300 can understand. As a result of the above operations, initially, the accessory managing portion 300 recognizes that the remote device 400 is not yet authorized, and limits the type of interactions permitted with the remote device 400 until the user of the programming environment requests authorization for the remote device 400, using the previously outlined “Authorize Accessory” command, for example. Then, the accessory authorization manager 350 and other elements of the accessory managing portion 300 perform the related authorization operations, for example, as outlined above with reference to FIGS. 5, 6, 7A, and 7B. The elements of the accessory managing portion 300 interact with the remote device 400 through the accessory management service 300S, which converts their data, instructions, or commands into information in a form that the remote device 400 can understand and use, and instructs the delivery service 340DS to deliver the information to the remote device 400. Responses in interactions from the remote device 400 may be delivered back to the accessory managing portion 300 by the delivery service 410DS, and converted in the accessory management service 300S to a form that the various elements of the accessory managing portion 300 can understand and use. In this way, operations as outlined above with reference to FIGS. 5-8, and other operations and features disclosed herein, may be accomplished by relatively unskilled users when using a variety of remote devices 400 that are not normally associated with a metrology system.

Regarding the indication of a current instruction representation 162cir on the remote device 400, in one embodiment, this may be implemented using the previously described node manager 190, inter-window auto scroll portion 195, and node association portion 330. As previously indicated, the node manager 190 is responsible for assigning and/or managing node numbers that are assigned to nodes (e.g., instruction representations) in a part program. The inter-window auto scroll portion 195 may utilize the node numbers to display associated part program elements and corresponding editing functions in different windows, routines, or applications, at the same time. In other words, the inter-window auto scroll portion 195 will cause respective windows to automatically scroll to the elements that correspond to the relevant node number. One exemplary method and/or implementation of inter-window communication is described below, with reference to FIG. 11, wherein the inter-window auto scroll portion 195 sends auto scroll notifications AS to various connected elements, including the node association portion 330, when it is notified of selection events SE in various connected elements. For example, a selection event SE occurs in the program representation window 161w each time the user changes the current (currently active) instruction representation 162cir to a new or different instruction representation. In response to receiving an auto scroll notification AS, the node association portion 330 may update its “current node number” and notify the accessory data manager 320 that any new set of reference information sent from the remote device 400 and received by the accessory data manager 320 through the accessory management service 300S should be associated with that new current node number. In addition, the node association portion 330 may notify the accessory operations user interface features 310 to send an updated display (e.g., an updated webpage or webpage element) indicating the new current instruction representation, to the remote device 400. The accessory operations user interface features 310 may then prepare the required updated display and send it to the accessory management service 300S for the proper formatting and delivery to the remote device 400. In some embodiments, the accessory management service 300S may use the notification service 340NS to notify the remote device 400 that such a delivery is available, whereupon the remote device 400 may request the delivery when it is compatible with its ongoing native operations.

Regarding the sending of a set of reference information from the remote device 400 to the accessory managing portion 300, the related previously described features and operations may be implemented as follows, in one embodiment. Once the user has prepared the set of reference information on the remote device (e.g., as previously outlined with reference to FIG. 7C), the user may activate the “SEND” button to initiate delivery. This may cause the notification service 410NS of the remote device 400 to issue a notification to the accessory managing portion 300 that such a delivery is available, whereupon the accessory managing portion 300 may request the delivery when it is compatible with its ongoing operations. When the set of reference information is delivered, the accessory management service 300S may prepare the information in a form usable by the accessory data manager 320 and/or the programming environment. The accessory data manager 320 may associate the set of reference information with the current node number and store it in the workpiece program memory 142 in a manner that supports that association.

Regarding the implementation of various web service methods, in addition to the large body of web surface teaching literature, U.S. Pat. Nos. 7,506,059; 8,346,929; 6,732,111; and 8,539,061, each of which is hereby incorporated herein by reference in its entirety, describe various methods that may be adapted to provide the features and operations described with reference to FIG. 10.

FIG. 11 is a functional schematic representation 1100 of one embodiment of communication routines and/or operations that may be implemented by an inter-window auto scroll portion 195. FIG. 11 schematically shows the inter-window auto scroll portion 195, a program representation (editing) window portion 161w, a client window portion 197 (e.g., another window in the programming environment, and the previously outlined node association portion 330 of the accessory managing portion 300. It should be understood that a “window portion” or “window” may include a displayed user interface, as well as its associated features and the underlying routines which provide its operations. It should also be understood that although the word “scroll” or “auto scroll” may be used herein, these words are used for convenience only, and are not limiting. More generally, an “auto scrolled” element may be made visible in its respective window, by any convenient and/or known method, including simply regenerating the window with the desired contents, or the like.

In the embodiment shown in FIG. 11, the inter-window auto scroll portion 195 interacts with window portions and the node association portion 330 through an auto scroll notification AS, and interacts with respective window portions through respective window selection event notifications SE. The various selection event notifications SE are triggered independently. That is, any window that is the host of selection of an element that is associated with a node number may issue a selection event notification SE in response to that selection, based on a routine or operations of that window that are triggered by the selection event. For example, a selection event occurs in the program representation window 161w each time the user changes the current (currently active) instruction representation 162cir to a new or different instruction representation. In contrast, in various embodiments, the auto scroll notifications AS sent to each applicable window are triggered in response to any selection event notification received by the inter-window auto scroll portion 195, and are generally sent to all applicable windows and the node association portion 330. The auto scroll notifications AS are based on a routine or operations of the Inter-Window Auto Scroll Portion 195 that are triggered by a selection event notification SE. The selection event notification SE may include the identifier or node number of the selected element (e.g., the identifier of the new current instruction representation), which may be passed through the auto scroll notification AS. As previously indicated, in response to receiving an auto scroll notification AS, the node association portion 330 may update its “current node number” and notify the accessory data manager 320 that any new set of reference information sent from the remote device 400 and received by the accessory data manager 320 through the accessory management service 300S should be associated with that new current node number. In addition, the node association portion 330 may notify the accessory operations user interface features 310 to send an updated display (e.g., an updated webpage or webpage element), indicating the new current instruction representation, to the remote device 400.

In one embodiment, FIG. 11 may be implemented using known “publisher-subscriber” methods, which are sometimes implemented using XML-like languages (e.g., as used for notifications between webpages). In various embodiments, a publisher-subscriber method may be implemented by adapting methods such as a list-based method, or a broadcast-based method, or a content-based method to support the features disclosed herein. In a machine vision inspection system, the publishers and subscribers are generally located in the same processing space, and it is possible for the identity of the “subscriber” windows to be known by the “publisher.” Applicable to such cases, U.S. Pat. No. 8,028,085 (“the '085 patent”), which is hereby incorporated herein by reference in its entirety, describes low latency methods that may be adapted to support the features disclosed with reference to FIG. 11.

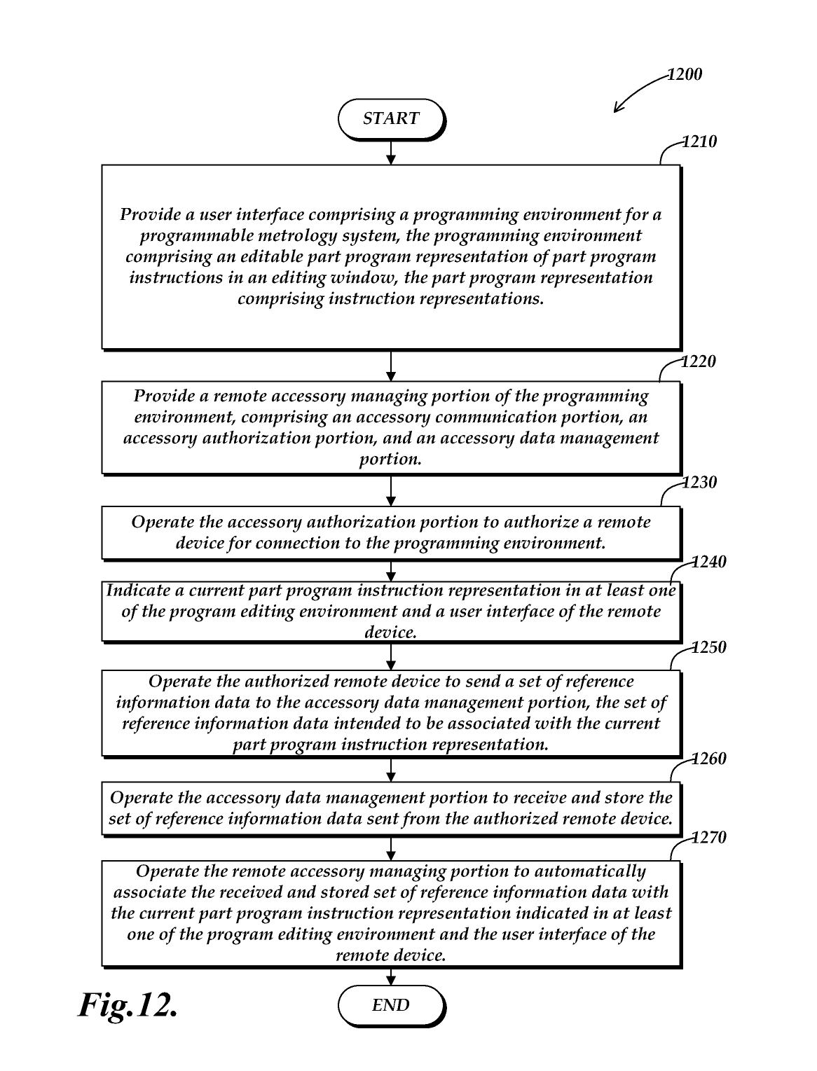

FIG. 12 is a flow diagram 1200 showing one exemplary embodiment of a method for operating an accessory managing portion of a programming environment of a programmable metrology system according to features and operations disclosed herein.

At block 1210, a user interface comprising a programming environment for a programmable metrology system is provided, the programming environment comprising an editable part program representation of part program instructions in an editing window, and the part program representation comprising instruction representations.

At block 1220, a remote accessory managing portion of the programming environment is provided, comprising an accessory communication portion, an accessory authorization portion, and an accessory data management portion.

At block 1230, the accessory authorization portion is operated to authorize a remote device for connection to the programming environment.

At block 1240, a current part program instruction representation is indicated in at least one of the program editing environment and a user interface of the remote device.

At block 1250, the authorized remote device is operated to send a set of reference information data to the accessory data management portion, the set of reference information data intended to be associated with the current part program instruction representation.

At block 1260, the accessory data management portion is operated to receive and store the set of reference information data sent from the authorized remote device.

At block 1270, the remote accessory managing portion is operated to automatically associate the received and stored set of reference information data with the current part program instruction representation indicated in at least one of the program editing environment and the user interface of the remote device.

From the foregoing, it will be appreciated that specific embodiments of the present disclosure have been described herein for purposes of illustration, but that various modifications may be made without deviating from the scope of the invention.

The embodiments of the invention in which an exclusive property or privilege is claimed are defined as follows:

1. A method for operating a programming environment of a programmable metrology system comprising a workpiece sensing portion; a stage for holding a workpiece; a control portion; a display; and a user interface comprising a programming environment that is operable during a learn mode of the programmable metrology system, the programming environment comprising an editable part program representation of part program instructions in an editing window, the part program representation comprising instruction representations,
the method comprising:
providing a remote accessory managing portion of the programming environment, comprising an accessory communication portion, an accessory authorization portion, and an accessory data management portion;
operating the accessory authorization portion to authorize a remote device for connection to the programming environment;
indicating a current part program instruction representation in at least one of the programming environment and a user interface of the remote device;
operating the authorized remote device to send a set of reference information data to the accessory data management portion, the set of reference information data intended to be associated with the current part program instruction representation;
operating the accessory data management portion to receive and store the set of reference information data sent from the authorized remote device; and
operating the accessory managing portion to automatically associate the received and stored set of reference information data with the current part program instruction representation indicated in at least one of the program editing environment and the user interface of the remote device.

2. The method of claim 1, further comprising:
displaying a reference information indicator in relation to the current part program instruction representation in the editing window, to indicate that its related part program instruction representation has a stored set of reference information available in association with it.

3. The method of claim 2, further comprising:
when its related part program instruction representation is a child node, and the parent node of that child node is collapsed in the editing window such that its child nodes are hidden, then automatically displaying the reference information indicator in relation to the part program instruction representation of the parent node.

4. The method of claim 2, further comprising:
operating the reference information indicator to activate operations usable to display the stored set of reference information corresponding to it.

5. The method of claim 2, wherein the reference information indicator is automatically displayed in relation to the current part program instruction representation in the editing window, in conjunction with operating the accessory managing portion to automatically associate the received and stored set of reference information data with the current part program instruction representation.

6. The method of claim 5, wherein operating the authorized remote device to send a set of reference information data to the accessory data management portion comprises sending the set of reference information data by operating a user interface feature of the remote device, and the method is performed without performing any prior user interface operations in the programming environment related to sending or receiving that set of reference information.

7. The method of claim 1, further comprising indicating the current part program instruction representation in both the program editing environment and the user interface of the remote device.

8. The method of claim 1, wherein the accessory authorization portion comprises an authorization user interface displayed in the programming environment, and the authorization user interface comprises instructions to be executed using a web browser included in the remote device.

9. The method of claim 8, wherein the accessory authorization portion comprises user interface features displayed using the web browser included in the remote device.

10. The method of claim 1, further comprising indicating the current part program instruction representation in a user interface of the remote device, wherein that user interface comprises user interface features provided using the accessory communication portion and displayed using a web browser included in the remote device.

11. The method of claim 1, wherein at least prior to authorizing the remote device for connection to the programming environment, the remote device includes no stored program or application customized to interact with the programming environment of the programmable metrology system.

12. The method of claim 11, wherein throughout the operations of the method the remote device includes no stored program or application customized to interact with the programming environment of the programmable metrology system.

13. The method of claim 12, wherein interaction between the remote device and the programming environment of the programmable metrology system is implemented using web services.

14. The method of claim 11, wherein, at least prior to authorizing the remote device for connection to the programming environment, interaction between the remote device and the programming environment of the programmable metrology system is implemented using web services.

15. The method of claim 1, wherein the remote device is a portable device not specifically associated with the programmable metrology system, and the method further comprises connecting the remote device to a network usable to connect to the programmable metrology system.

16. The method of claim 15, wherein the remote device is one of a digital camera, a smart phone, and a portable computer.

17. A programmable metrology system comprising a workpiece sensing portion; a stage for holding a workpiece; a control portion; a display; and a user interface comprising a programming environment that is operable during a learn mode of the programmable metrology system, the programming environment comprising an editable part program representation of part program instructions in an editing window, the part program representation comprising instruction representations,
wherein the programming environment further comprises a remote accessory managing portion comprising:
an accessory communication portion configured to communicate with a remote device;
an accessory authorization portion configured to authorize the remote device for connection to the programming environment; and
an accessory data management portion configured to receive and store a set of reference information data from the authorized remote device,
wherein the remote accessory managing portion is configured such that when an authorized remote device sends the set of reference information data to the accessory data management portion, it is automatically associated with a current part program instruction representation indicated in at least one of the program editing environment and a user interface of the remote device.

18. The programmable metrology system of claim 17, wherein:
the user interface comprises a reference information indicator displayed in relation to the current part program instruction representation in the editing window, to indicate that its related part program instruction representation has a stored set of reference information available in association with it; and
the user interface is configured such that, when a user interface feature of the remote device is operated to send the set of reference information data to the accessory data management portion, then the reference information indicator is automatically displayed in relation to the current part program instruction representation in the editing window in conjunction with operating the accessory managing portion to automatically associate the received and stored set of reference information data with the current part program instruction representation, without performing any prior user interface operations in the programming environment related to sending or receiving that set of reference information.

19. The programmable metrology system of claim 17, wherein the remote accessory managing portion is configured such that:
the remote device may be a portable device not specifically associated with the programmable metrology system; and
at least prior to authorizing the remote device for connection to the programming environment, the remote device need not include a stored program or application customized to interact with the programming environment of the programmable metrology system.

20. The programmable metrology system of claim 19, wherein the remote accessory managing portion is configured such that:
a user interface of the remote device comprises user interface features provided using the accessory communication portion and displayed using a web browser included in the remote device; and
interaction between the remote device and the programming environment of the programmable metrology system is implemented using elements comprising web services.
